(19) United States
(12) Patent Application Publication
(10) Pub. No.: US 2009/0213123 A1
(43) Pub. Date: Aug. 27, 2009

(54) Method of using skeletal animation data to ascertain risk in a surveillance system

(76) Inventor: Dennis Allard Crow, Irvine, CA (US)

Correspondence Address: GEARHART LAW, LLC, 4 FERNDALE ROAD, CHATHAM, NJ, 07928, US

(21) Appl. No.: 12/315,714

(22) Filed: Dec. 6, 2008

Related U.S. Application Data
(60) Provisional application No. 61/005,797, filed on Dec. 8, 2007.

(51) Int. Cl. G06T 15/70; H04N 7/18

(52) U.S. Cl. 345/473; 348/143; 348/E07.085

(57) ABSTRACT

The present invention discloses a method of surveillance comprising the steps of matching skeletal animation data representative of recorded motion to a pre-defined animation. The pre-defined animation is associated with a risk value. An end-user is also provided with at least the recorded motion as well as a risk value. The method may be carried out in real time and the skeletal animation data may be three-dimensional.

### CLAIM OF PRIORITY

This application claims the priority of U.S. Ser. No. 61/005,797 filed on Dec. 8, 2007, which is incorporated herein by reference.

### BACKGROUND OF THE INVENTION

Surveillance systems capable of detecting suspicious movements of individuals are known in the art. These systems typically function by examining surveillance videos, detecting the position and movement of individuals, and comparing the movement to previously recorded movement. Depending on the closeness of movement detected, a risk value is assigned to the action and an end-user may be notified.

Such surveillance systems are utilized, inter alia, by banks, ATMs, hotels, schools, residence halls and dormitories, office and residential buildings, hospitals, sidewalks, street crossings, parks, containers and container loading areas, shipping piers, train stations, truck loading stations, airport passenger and freight facilities, bus stations, subway stations, theaters, concert halls, sport arenas, libraries, churches, museums, stores, shopping malls, restaurants, convenience stores, bars, coffee shops, gasoline stations, highway rest stops, tunnels, bridges, gateways, sections of highways, toll booths, warehouses and depots, factories and assembly rooms, as well as law enforcement facilities, including jails. Any location or facility, civilian or military, requiring security would be a likely user.

However, prior art references teach limited functionality. When a single video camera is used, motion is seen in only two dimensions. Further, while such references function by comparing observed movements in the video camera with predetermined movements, since the observed and predetermined movements are based on the motion of a person, the motions must be rather large, such as walking fast across a room or moving one's arm abruptly, and many frames are needed to use as a reference.

The above limitations of the prior art contribute to coarse and sometimes inaccurate results, including false positives and failure to detect behavior which is truly suspicious. The sampling of entire body movements and the need to take into account the appearance of these movements across cultural, sexual, and age boundaries require a high amount of computer processing power and storage space. Still further, the same object and same suspicious movement of the object can be anywhere on the screen. Thus, the movement may be displayed throughout the entire frame of view of a camera or only encompass a few pixels. Beyond that, when multiple objects, including people, are present in a surveillance area, the processing power necessary to sample movement increases substantially and can be hampered, for example, by the crossing of paths, particularly when one person walks between the eye of the camera and another person. Prior art systems tend to be limited to surveillance of a single person or a few people or objects at a time. This is because as complexity is added, at least in part, processing power, storage space and false positives increase rapidly. Such prior art surveillance systems tend to be both expensive and lacking in reliability.

Moreover, prior art systems detect movement only when it is substantially in the same direction of movement of objects to which it is being compared. For example, a person walking across the surveyed area from left to right will not be matched with recorded motion of a person walking across the screen from the top to the bottom. In such cases, the former may not be suspicious movement but could be indicative of an individual moving instead of towards a bank teller on the right, towards a bank safe at the top of a frame. Thus, each such direction of movement must be programmed specifically unless other workarounds are applied.

One such system known in the art is disclosed in U.S. Pat. No. 5,666,157 to Aviv which discloses a video surveillance system with means for sampling movements of an individual and comparing the movements to predetermined characteristics of movements. The above discussed limitations, including the limiting of sampling to two dimensions, is found in this reference.

More recent references have attempted to solve the above limitations in a variety of ways. For example, U.S. Pat. No. 7,136,507 to Han, et al., discloses at least causing an alert condition in a surveillance system when a predetermined pattern of movement is detected relative only to a fixed object, another person, or a zone which is designated as a secured area. This method decreases the volume of detected suspicious movements by limiting such detection to a specific subset of movements, but is similar to the U.S. Pat. No. 5,666,157, reference in other ways.

U.S. Pat. No. 6,940,998 to Garoutte discloses a surveillance system taking into account the terrain of the surveyed area and position of people as well as cars. The surveyed area is divided into portions and based on the portion and percentage filled by an object, the nature of the object is determined, such as a head of a person. Velocity of the object is calculated based on the movement in and out of the quadrant. However, this reference also suffers from similar drawbacks as the other prior art.

Thus, it has been a long felt and sought after need to provide an automated or semi-automated surveillance system which can alert an end-user of suspicious activity. It is desired that such a system and a method of implementing the system be inexpensive to produce and require minimal computational resources, including storage space and processor usage. Such a system would allow for a greater amount of predetermined movement samples to be stored and for such movement samples to be compared to observed movement at a greater rate.

Still further, it is desired that suspicious movements be detected regardless of where in the frame of view the movement is taking place and covering the broadest range of movements, whether by an individual or a group of people. Additionally, it is desired to detect the movement of animals.

### SUMMARY OF THE INVENTION

An object of the present invention includes decreasing processing time in surveillance systems, especially real-time surveillance, so that a greater amount of matches can be analyzed.

Another object of the invention is to conduct surveillance in three dimensions and match movements regardless of the direction of movement of an individual.

Yet another object of the invention is to recognize movements, and especially high risk movements, regardless of the age or size of a surveyed individual or group of individuals.

Still further objects of the invention will become clear in the disclosure below.

The present invention discloses a method of surveillance comprising the steps of matching skeletal animation data representative of recorded motion to a pre-defined animation. The pre-defined animation is associated with a risk value. An end-user is also provided with at least the recorded motion and a risk value. The method may be carried out in real time and the skeletal animation data may be three dimensional.

The end-user may receive notification only when the risk value associated with the skeletal animation data is high, that is, above a certain designated threshold. The method may also include the step of having a user evaluate the recorded motion to determine the level of risk.

The matching may be an exact match or based on a closest available match.

The motion may be recorded using at least one video camera and may comprise at least a portion of a human's anatomy, an entire person, or a plurality of people.

An electronic surveillance system may be adapted to carry out the above-method.

A device with means for carrying out the above method steps is also claimed as part of the invention. Further, the device may be a computer-readable storage medium on which stored instructions are executable by a processor.

### BRIEF DESCRIPTION OF THE DRAWINGS

FIG. 1 shows a block diagram of a suitable computing environment in which the invention may be implemented.

FIG. 2 shows a prior art system for plotting skeletal animation data of an individual.

FIG. 3 shows an overview of the steps taking an embodiment of the method of carrying out the invention.

FIGS. 4A and 4B are screenshots of skeletal animation data representative of data used in embodiments of the system and method of the present invention.

### DETAILED DESCRIPTION

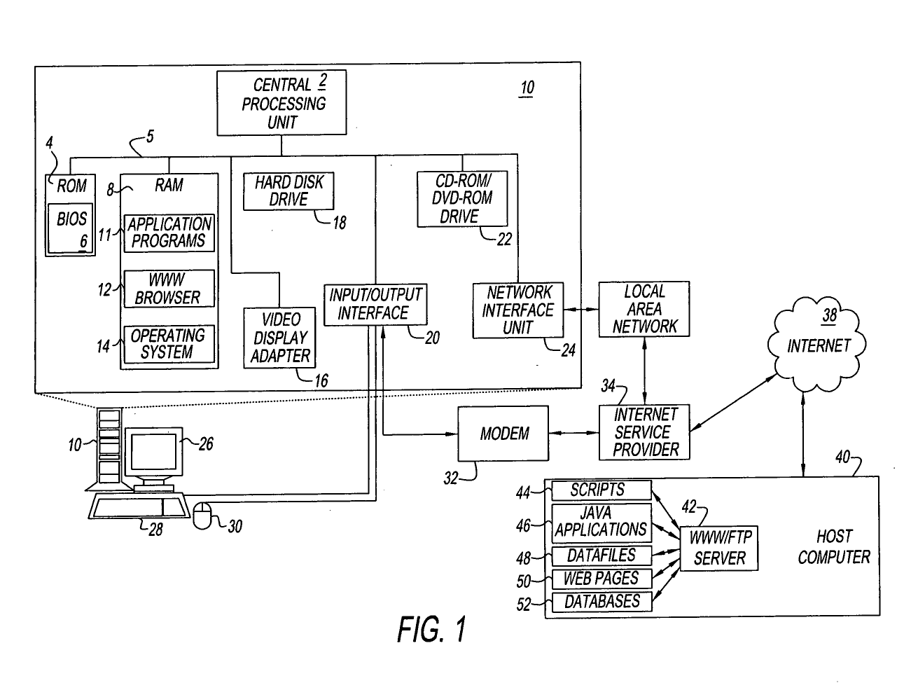

FIG. 1 shows a block diagram of a suitable computing environment in which the invention may be implemented. Referring now to FIG. 1, an illustrative environment for implementing the invention includes a conventional personal computer 100, including a processing unit 102, a system memory, including read only memory (ROM) 104, a random access memory (RAM) 108, and a system bus 105 that couples the system memory to the processing unit 102. The read only memory (ROM) 104 includes a basic input/output system 106 (BIOS), containing the basic routines that help to transfer information between elements within the personal computer 100, such as during start-up. The personal computer 100 further includes a hard disk drive 118 and an optical disk drive 122, e.g., for reading a CD-ROM disk or DVD disk, or to read from or write to other optical media. The drives and their associated computer-readable media provide nonvolatile storage for the personal computer 100. Although the description of computer-readable media above refers to a hard disk, a removable magnetic disk and a CD-ROM or DVD-ROM disk, it should be appreciated by those skilled in the art that other types of media readable by a computer, such as magnetic cassettes, flash memory cards, digital video disks, Bernoulli cartridges, and the like, may also be used in the illustrative operating environment.

A number of program modules may be stored in the drives and RAM 108, including an operating system 114 and one or more application programs 110, for instance a program for browsing the world-wide-web, such as WWW browser 112. Such program modules may be stored on hard disk drive 118 and loaded into RAM 108 either partially or fully for execution.

A user may enter commands and information into the personal computer 100 through a keyboard 128 and pointing device, such as a mouse 130. Other control input devices (not shown) may include a microphone, joystick, game pad, satellite dish, scanner, or the like. These and other input devices are often connected to the processing unit 100 through an input/output interface 120 that is coupled to the system bus, but may be connected by other interfaces, such as a game port, universal serial bus, or firewire port. A display monitor 126 or other type of display device is also connected to the system bus 105 via an interface, such as a video display adapter 116. In addition to the monitor, personal computers typically include other peripheral output devices (not shown), such as speakers or printers. The personal computer 100 may be capable of displaying a graphical user interface on monitor 126.

The personal computer 100 may operate in a networked environment using logical connections to one or more remote computers, such as a server or host computer 140. The host computer 140 may be a server, a router, a peer device, or other common network node, and typically includes many or all of the elements described relative to the personal computer 100. The LAN 136 may be further connected to an internet service provider 134 (“ISP”) for access to the Internet 138. In this manner, WWW browser 112 may connect to host computer 140 through LAN 136, ISP 134, and the Internet 138. Such networking environments are commonplace in offices, enterprise-wide computer networks, intranets and the Internet.

When used in a LAN networking environment, the personal computer 100 is connected to the LAN 136 through a network interface unit 124. When used in a WAN networking environment, the personal computer 100 typically includes a modem 132 or other means for establishing communications through the Internet service provider 134 to the Internet. The modem 132, which may be internal or external, is connected to the system bus 105 via the input/output interface 120. It will be appreciated that the network connections shown are illustrative and that other means of establishing a communications link between the computers may be used.

The operating system 114 generally controls the operation of the previously discussed personal computer 100, including input/output operations. In the illustrative operating environment, the invention is used in conjunction with Microsoft Corporation's “Windows Vista” operating system and a WWW browser 112, such as Microsoft Corporation's Internet Explorer or Mozilla Corporation's Firefox, operating under this operating system. However, it should be understood that the invention can be implemented for use with other operating systems, such as “WINDOWS XP,” “MacOS,” “Linu,” “Ubuntu,” “PalmOS,” “OS/2,” “SOLARIS” and the like. Likewise, the invention may be implemented for use with other WWW browsers known to those skilled in the art.

Host computer 140 is also connected to the Internet 138, and may contain components similar to those contained in personal computer 100 described above. Additionally, host computer 140 may execute an application program for receiving requests for WWW pages, and for serving such pages to the requester, such as WWW server 142. According to an embodiment of the present invention, WWW server 142 may receive requests for WWW pages 150 or other documents from WWW browser 112. In response to these requests, WWW server 142 may transmit WWW pages 150 comprising hyper-text markup language (“HTML”) or other markup language files, such as active server pages, to WWW browser 112. Likewise, WWW server 142 may also transmit requested data files 148, such as graphical images or text information, to WWW browser 112. WWW server may also execute scripts 144, such as PHP, CGI or PERL scripts, to dynamically produce WWW pages 150 for transmission to WWW browser 112. WWW server 142 may also transmit scripts 144, such as a script written in JavaScript, to WWW browser 112 for execution. Similarly, WWW server 142 may transmit programs written in the Java programming language, developed by Sun Microsystems, Inc., to WWW browser 112 for execution. As will be described in more detail below, aspects of the present invention may be embodied in application programs executed by host computer 142, such as scripts 144, or may be embodied in application programs executed by computer 100, such as Java applications 146. Those skilled in the art will appreciate that aspects of the invention may also be embodied in a stand-alone application program.

The methods and devices of the invention proceed by analyzing skeletal animation data. Systems and methods of producing skeletal animation data are known in the art, such as are disclosed in U.S. Pat. No. 6,522,332 to Lanciault, et al., which is hereby incorporated by reference. Such references disclose using one or more cameras to record the motion of a person and track the position of the person and appendages of the person over time. These data are typically rendered as a series of moving dots in three dimensions and comprise skeletal animation data wherein a rough position of various features of a person's skeletal system, representing skeletal animation data, are plotted in three dimensions.

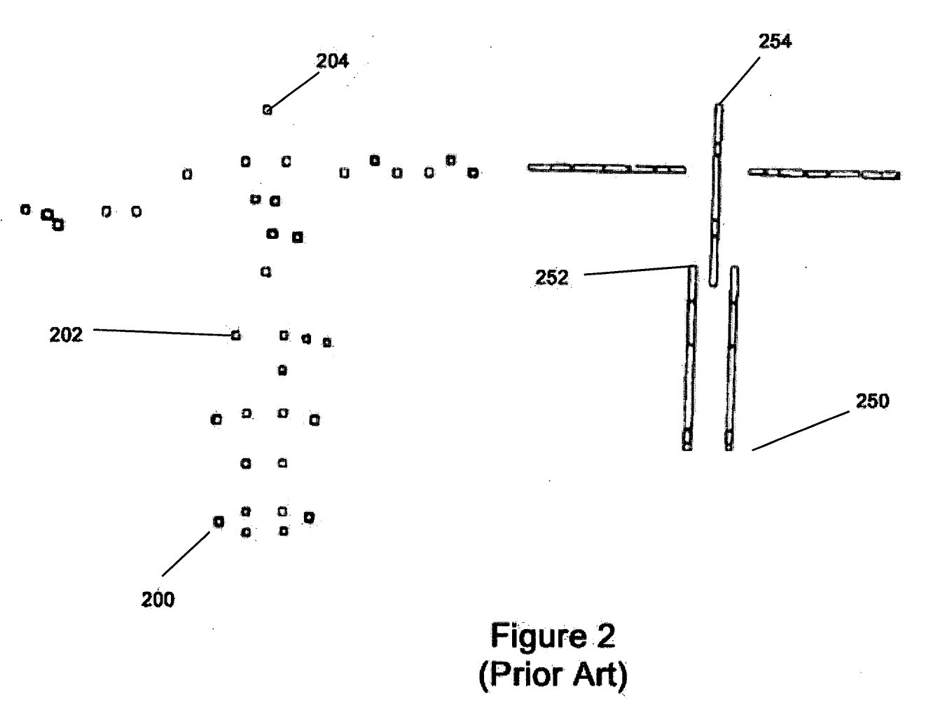

FIG. 2 shows a prior art system for plotting skeletal animation data of an individual. While FIG. 2 shows a single frame of motion of an individual, a typical prior art system and the present system and method of the invention utilize the tracking of movement over various frames as is known in the art. Plot 200 shows a skeletal markup of points that make up a person which have been detected by such a prior art system. For illustrative purposes, the right hip 202 and top of the head 204 have been labeled. To illustrate more clearly what this skeletal markup looks like to the computer, the detected points can be normalized and connected to provide a stick figure-like illustration of the person, as shown in plot 250. The hip 202 is designated as hip 252 in plot 250. Similarly, the top of the head 204 has been designated as top of the head 254 in plot 250.

Most prior art systems function by placing markers over a person's body and detecting the position of the markers. While the present invention can be practiced on such a prior art system, new systems and methods have been developed which do not require the use of markers and are useful in the field of surveillance, where the person to be surveyed is generally an unwanted intruder or dangerous person in a public space and the use of markers is prohibitive.

One system of this type, which can create such skeletal animation data for use with the invention, has been disclosed and sold to the general public by Organic Motion Inc. and is believed to have been described in detail in one or more patent applications prior to the filing of the present application. The Organic Motion system uses multiple 2D video cameras to track a subject. The data output from each camera is fed into a vision processor which maps and triangulates the location of the subject by determining where the various camera images intersect. In this manner, the Organic Motion system looks at a scenario in a way a human looks at a complex scene: head, hands and rapidly moving body parts hold more of our attention than static elements. Organic Motion's system processes hundreds of megabytes of data per second and delivers highly accurate real-time tracking results at high frame rates. The final output is a full 3D model of the subject. The output can be complete with surface mesh geometry, surface textures and 3D bone movement data precise to 1 mm. Through this process, Organic Motion's technology eliminates the need for markers and can be used to survey an area. At the present time, the Organic Motion system is capable of surveying an area of up to 4 m×4 m×2.5 m (approximately 12 ft×12 ft×7.5 ft), and it is contemplated and within the scope of the invention to combine multiple such systems in succession to cover a greater area for use with the surveillance system of the present invention.

Other key features of the Organic Motion system which are particularly well suited for use in the present invention are the mapping of 21 bones with 6 degrees of freedom, use with artificial or natural lighting, use of high speed cameras (60-120 fps), and tracking of multiple people and objects.

Thus, any prior art method of obtaining skeletal animation data of an individual may be used with the system and method of the invention.

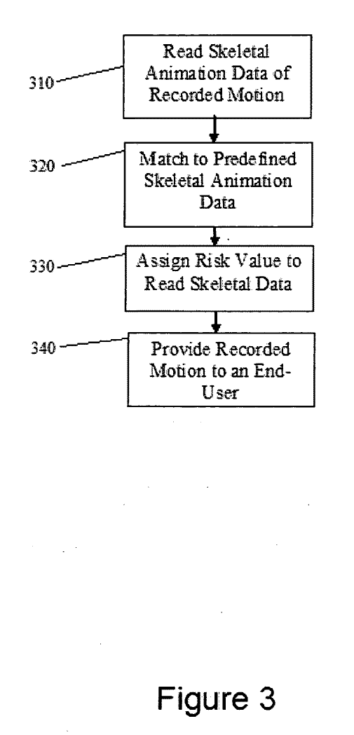

FIG. 3 shows an overview of the steps taken in an embodiment of the method of carrying out the invention. In step 310, skeletal animation data representative of recorded motion is read. The recorded motion can be motion recorded at any time but is typically motion that has just been recorded, and it includes motion which is being recorded live and converted in real-time or near real time into skeletal animation data. Thus, the process of recording the motion and providing the motion as skeletal animation data may be a matter of a few milliseconds or may be prior recorded data.

In step 320, the recorded skeletal animation data provided in step 310 are compared to a library of predefined skeletal animation data. Such a library is of small size, as only the X, Y, and Z coordinates of various plotted points on the skeleton of a person, appendage of a person, animal, or the like need be stored. A risk value is additionally associated with each such stored skeletal animation data. The stored points are relative to each other in such a manner as to be easily scalable, depending on the size of the object being read. Thus, for example, a six foot tall man might have the top of his head at position 0 in, 72 in, 0 in on an x, y, z plane, and the tip of his hand at 12 in, 40 in, 0 in in the same plane, where “in” is inches. To scale this to a three foot tall child, the same predefined animation data can be used, wherein the measurements are scaled to 0 in, 36 in, 0 in and 6 in, 20 in, 0 in, respectively. It should be understood by one having skill in the art that the recorded skeletal animation data will comprise multiple frames in series and designated tolerance levels, such as plus or minus 1% or 5%, to determine if the recorded motion of step 310 matches a predefined skeletal animation as occurs in step 320. Depending on the threat level, operating environment, and precision of the equipment used to record the skeletal animation data, the tolerance level can be decreased or increased as necessary. The tolerance level can be normalized over many frames or require all recorded frames to be within the set tolerance level of the skeletal motion in predefined animation data. If this fails, a match may be chosen based on which motion in a skeletal animation library matches most closely. Such a matching mechanism may be useful when the predefined skeletal animation library comprises a high amount of animation data, such as greater than 5,000 or 25,000 animations, wherein the closest match is likely to be a correct match, in that the same or a similar action is taking place in both the recorded motion of step 310 and the skeletal animation library used in step 320. Using this or a similar method, the skeletal animation data are matched.

Since the present invention compares motion at the level of skeletal animation and not at the level of comparing actual recorded movement, large animation libraries may be stored in a relatively small amount of space. Comparisons of many moving bodies, including individuals, appendages (especially when a full view of a person is not available), and even animals can take place. This is both possible and feasible in real-time or near real-time (defined as a time period under one second for purposes of this application), because skeletal animation data require far less processing power and storage space than typical prior art surveillance systems which compare at lower levels of abstraction, such as comparing actual video sequences. For example, a 9 second skeletal animation sequence of a person walking can be stored in 46 kb of space. At the time of filing of the invention, peak RAM (random access memory) read speeds available to the public are approaching 12,800 MB/s. Thus, upwards of 280,000 skeletal animations could be read in a single second using present technology. As data read speeds and processor speeds increase, the number of skeletal animations which can be compared in real-time will continue to increase.

Still further, given the amount of animations which can be provided and efficiently compared to the prior art systems, the level of accuracy can be greatly increased. For example, the movement of someone waving a grenade, a high risk activity, may look similar to someone waving a small flag, a low risk activity. It would be clear to a human observer viewing the waving motion of the arm of each individual that the motions are different because, for example, when each arm reaches its lowest point, there will be a slight pause until the arm starts moving upwards (increasing in the y direction) again. By contrast, a holder of a small flag will be able to move his arm upwards again immediately because the weight of the flag is minimal. Where a user of a smaller size is concerned, it may be necessary to make adjustments appropriate to the size. In this example, a small child is likely to need more recoil time with a heavier object than an adult. It should be obvious to one having ordinary skill in the art that thousands of variations on this theme are possible and contemplated as within the scope of the invention.

In step 330, the recorded motion is assigned a risk value associated with its matched, or closest matched, predefined skeletal animation data. Each predefined skeletal animation is associated with a risk value. Risk values may be assigned on a sliding scale and have a near-infinite number of gradations. For example, the scale may be from 1 to 1000 or 1 to 5 including only whole numbers, or from 0 to 1 including gradations of 1/1000^{th}.

Thus, for example, a particular predefined skeletal animation may be assigned a risk value of 875 on a scale from 1 to 1000. If this is the closest match to the skeletal animation derived from the recorded motion in step 310, then the skeletal animation will be assigned a risk value of 875. In alternative embodiments of the invention, the risk value assigned to the recorded motion may be adjusted. For example, if the match is closest to a predefined skeletal animation having a risk value of 875, but parts of the recorded motion match a predefined skeletal animation associated with a risk value of 995, it may be desired to provide a risk value which is averaged or weighted between 875 and 995. The weighting of assignment of risk value may be based on proximity of the match, length of time that the match occurs, and further data associated to a predefined skeletal animation indicative of priority. For example, first predefined skeletal animation data may have priority over second predefined skeletal animation data. If the recorded motion of step 310 is within a tolerance level of both predefined skeletal animations, then the first skeletal animation with higher priority will either be weighted higher or used to assign a risk value in total. Combinations of these embodiments described above are also contemplated.

In step 340, at least the recorded motion is provided to an end-user. Typically, such an end-user is viewing a bank of security cameras. In this method of the invention, a display of the recorded motion will be provided to an end-user for viewing. The risk value associated with the recorded motion may also be displayed. The video may be provided to the end-user only if the risk value is above a certain threshold indicative of a high risk. In a separate embodiment of the invention, or in combination with the above, an audible or visual notification may be provided to the end-user to inform the end-user that a particular display needs his attention. In a further embodiment of the invention, the skeletal animation data may be displayed to the end-user together with or separate from the recorded motion. These skeletal animation data may be rendered as points, lines, or a two or three-dimensional animation of a person, plurality of people, appendage of a person, animal, and the like.

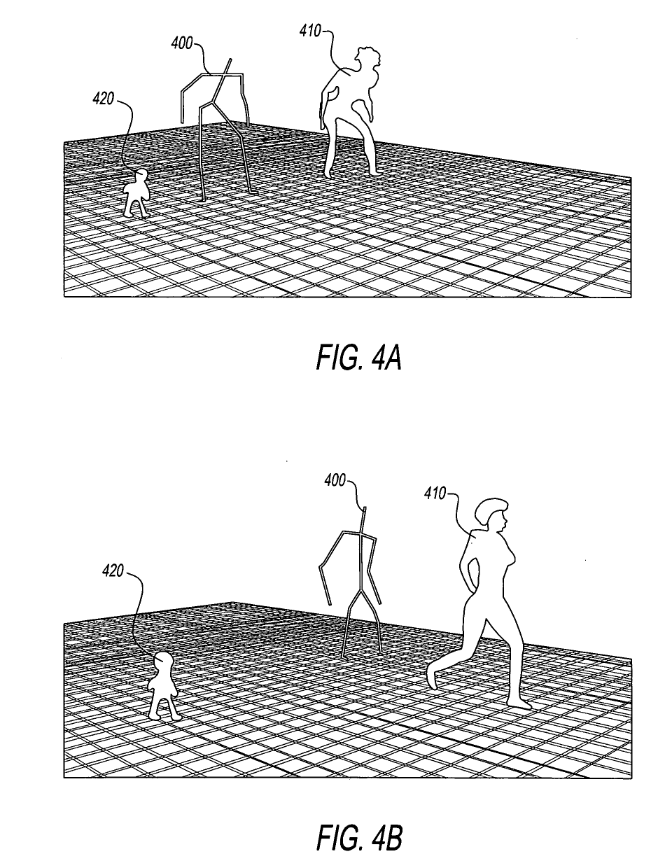

FIGS. 4A and 4B are screenshots of skeletal animation data representative of data used in embodiments of the system and method of the present invention. The figures depict rendered data in a frame of an animation. FIG. 4A depicts a first frame at a starting point of the animation, and FIG. 4B depicts a second frame later in the animation. The animation is a computerized rendition of an individual resting in a starting position (depicted in FIG. 4A) and then running (depicted in FIG. 4B).

The screenshots are provided for illustrative purposes, in order to better understand the invention; however, such renderings as shown in the figures may be used in conjunction with, or as an additional step of, the invention, such as by displaying such a rendering alongside the video feed. The rendering may be of the predefined animation or the presently recorded animation.

Still further, both a predefined animation and a presently recorded animation may be displayed to an end-user for comparison purposes and, in addition, for use in indicating to a system used to practice the invention that such a match is a false positive. Thus, the system of the invention can learn to recognize false positives and not return such a result a second time.

Stick person 400 is a line drawing connecting the detected points or a normalization of the detected points of an individual. Such a stick person 400 is a drawing of data representative of the positions of a person at a particular moment in time, such as is shown in FIGS. 4A and 4B and, by extension, at set intervals of time (such as 1/60^{th} or 1/120^{th} of a second) between the times shown in FIGS. 4A and 4B (which is about 9 seconds in this example). Heather 410 is a rendition of the line drawing of stick person 400 in an adult female form. Joshua 420 is a rendition of the line drawing of stick person 400 in the form of a small boy. Thus, as can be seen by comparing the distance moved of Heather 410 and Joshua 420 from substantially the same starting point in FIG. 4A to the respective ending points in FIG. 4B, the distances traveled are quite different. However, the same skeletal movements are representative of movements in both Heather 410 and Joshua 420.

As has been noted previously, the method of the invention proceeds by using skeletal animation data and comparing such animation data to predefined skeletal animation data associated with a risk value. As should be appreciated by one having skill in the art from the description of FIGS. 4A and 4B, at the level of skeletal data, comparisons can be made rapidly and regardless of the size and shape of the individuals compared. First, comparisons are at the level of comparing x, y, and z positions over time, allowing for decreased computational resources compared to the prior art and more accurate results. Second, comparisons need not be between like individuals. The predefined animation data may garnered from movements of a 24 year old female, but the recorded animations may be those of a 3 year old boy. In addition, because comparisons are done at a level of comparing x, y, and z positions, such as by comparing vectors relative to one another, the motions can be in any direction on the plane and still be detected. However, in general it will be necessary to limit comparisons to two of the three planes (such as by comparing walking motions on an x, y plane because a change in the value of z would no longer be walking). Velocity and other considerations can be dynamically taken into account for individuals of different sizes, and multiple people can be analyzed and compared at one time to each other and to predefined animation data. Thus, many more successful matches can be made with far fewer data than used in the prior art, and the matches will be of higher quality.

Still further, the method of the invention is adaptable for use with animals and inanimate objects. For example, positions of a head, shoulder, hip, other joints, and feet of a wolf, raccoon, and the like can be defined in an animation, detected, compared, and assigned a risk value. Such a use might be necessary in surveillance of a zoo, animal preserve, or waste facilities.

It is understood that the processing of information as described herein can take place on a grid system, or cameras or components of the system can be networked in a variety of configurations. For example, various separate users could connect to a single data base, allowing sharing of data and processing power.

The above is a general description of embodiments of the invention. However, examples in the above disclosure are illustrative of the invention and not intended to limit the scope of the invention. Other embodiments are contemplated which are both within the scope and spirit of the application.

1. A method of surveillance comprising the steps of:
matching skeletal animation data representative of recorded motion to a pre-defined animation wherein said pre-defined animation is associated with a risk value;
providing at least said recorded motion and said risk value to an end-user.

2. The method of claim 1, wherein said method is carried out in real time.

3. The method of claim 1, wherein said skeletal animation data are three-dimensional.

4. The method of claim 1, wherein when said risk value is above a threshold, said risk value is designated as high risk and said end-user receives notification

5. The method of claim 1, wherein said matching is based on a closest available match.

6. The method of claim 1, wherein said recorded motion is recorded using at least one video camera.

7. The method of claim 1, further comprising the step of user evaluation of said recorded motion to determine risk.

8. The method of claim 1, wherein said recorded motion comprises recorded motion of at least a portion of a human's anatomy.

9. The method of claim 1, wherein said recorded motion comprises recorded motion of a plurality of people.

10. An electronic surveillance system adapted to carry out the method defined in claim 1.

11. A device for surveillance comprising:
means for matching skeletal animation data representative of recorded motion to a pre-defined animation, wherein said pre-defined animation is associated with a risk value;
means for providing at least said recorded motion and said risk value to an end-user.

12. The device of claim 11, wherein said surveillance is carried out in real time.

13. The device of claim 11, wherein said skeletal animation data are three-dimensional.

14. The device of claim 11, wherein when said risk value is above a threshold, said risk value is designated as high risk and said end-user receives notification.

15. The device of claim 11, wherein said matching is based on a closest available match.

17. The device of claim 11, wherein said recorded motion is recorded using at least one video camera.

18. The device of claim 11, wherein said record motion comprises recorded motion of at least a portion of a human's anatomy.

19. The device of claim 11, wherein said recorded motion comprises recorded motion of a plurality of people.

20. A computer-readable storage medium on which are stored instructions that are executable by a processor comprising the means as defined in claim 11.
